(19) United States
(12) Patent Application Publication
(10) Pub. No.: US 2008/0292017 A1
(43) Pub. Date: Nov. 27, 2008

(54) Modulation of Data Streams With Constellation Subset Mapping

(75) Inventors: Gunnar Wetzker, Eindhoven (NL); Constant Paul Marie Jozef Baggen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,518

(22) PCT Filed: Jun. 14, 2005
(86) PCT No.: PCT/IB05/51950

§ 371 Date: Dec. 13, 2006

(30) Foreign Application Priority Data
Jun. 21, 2004 (EP) 04102850.7

(51) Int. Cl. H04L 27/00; H04L 27/06

(52) U.S. Cl. 375/295; 375/340

(57) ABSTRACT

In a method for encoding at least two data streams (p₁ . . . pₙ), a bit sequence of each one of the at least two data streams (p₁ . . . pₙ) is mapped onto a symbol in a predefined order which is part of one of at least two subsets (I, II, Iₐ, I_{b}, IIₐ, II_{b}) of a modulation constellation. The one of at least two subset (I, II, Iₐ, I_{b}, IIₐ, II_{b}) is determined by an encoding rule that is having regard to the symbols (s₁ . . . s₁₆) that already have been used for encoding bit sequences of preceding data streams (p₁ . . . pₙ)

The invention relates to a method for encoding at least two data streams and to a transmitter using such encoding method. The invention further relates to a method for decoding at least two data streams. Additionally, the invention relates to a telecommunication system comprising such transmitter and or receiver. Such transmitter or receivers can e.g. be a base station in a mobile network or a mobile phone or a personal digital assistant (PDA). Alternatively such transmitter and or receiver could be built into a personal computer, or it could be a network interface card (NIC), which could be inserted into a (portable) personal computer.

Such method is known from the published United States Patent Application US 2003/0043929 A1. Shown is a telecommunication system comprising a transmitter and a receiver, each having multiple antennae for the transmission and reception of signals. According, to the US patent, the transmission can be optimized by preprocessing the transmit signals. The method includes generation of a representative correlation matrix that represents the antenna correlation. The antenna correlation can be determined at the receiver, and can be fed back to the transmitter. Feedback however, increases system complexity, which is unwanted.

It is therefore an object of the invention to provide a method for encoding at least two data streams that can be simultaneously transmitted to a receiver without requiring feedback, this object can according to the invention be realized by using a method for encoding at least two data streams wherein the at least two data streams are encoded by mapping a bit sequence of each one of the at least two data streams in a predefined order onto a symbol which is part of one of at least two subsets of a modulation constellation in which the one of at least two subset is determined by an encoding rule that is having regard to the symbols that already have been used for encoding bit sequences of preceding data streams.

The invention is based upon the insight that the communication channels, through which the data streams propagate from transmitter to receiver, differ in attenuation and in phase rotation. Due to the differences in attenuation of the communication channels, the transmitted data streams are received having different Signal to Noise ratios. Moreover, the stream having the lowest Signal to Noise Ratio determines to a large extent the overall system performance. This problem could be remedied by transmitting less data over the channel having the worst SNR and transmitting the maximum amount of data over the best channel. However, this would still require a feedback from receiver to transmitter, which is clearly unwanted. According to the invention it is possible to achieve the same goal by using a modulation scheme wherein (1) the data streams are encoded in a predefined order and (2) the bit sequences of each one of the at least two data streams is encoded using subsets of the modulation constellation, which subset is determined according to a certain (encoding) rule which uses the symbols of previously encoded bit sequences as input. This allows a more reliable demodulation of the data streams since due to the use of subsets, the freedom of choice for demapping the data stream i.e. determining which symbol has been transmitted, is reduced.

In an embodiment of a method of decoding at least two data streams, the method comprises the steps of:

determining an order for decoding each one of the encoded at least two data streams; and

decoding each one of the at least two data streams in the decoding order by demapping a symbol of each one of the at least two data streams back into bits using one of at least two subsets of the modulation constellation, in which the one of at least two subsets is determined by a decoding rule that is having regard to the symbols of preceding data streams that already have been demapped. Using the decoding rule, the receiver is able to work out which of the subsets have been used to encode each one of the at least two data streams. Since each subset comprises fewer symbols than the modulation constellation itself, the freedom of choice for a receiver is reduced during the demodulation of the streams, which improves their reliability.

In another embodiment of the method of decoding the at least two data streams, the order of decoding is determined by the signal to noise ratio's of each one of the at least two signals. This way it can be assured that the most reliable signal is decoded first.

These and other aspects of the invention will be further elucidated by means of the following drawings.

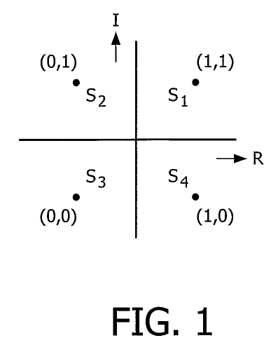

FIG. 1 shows a QPSK modulation constellation.

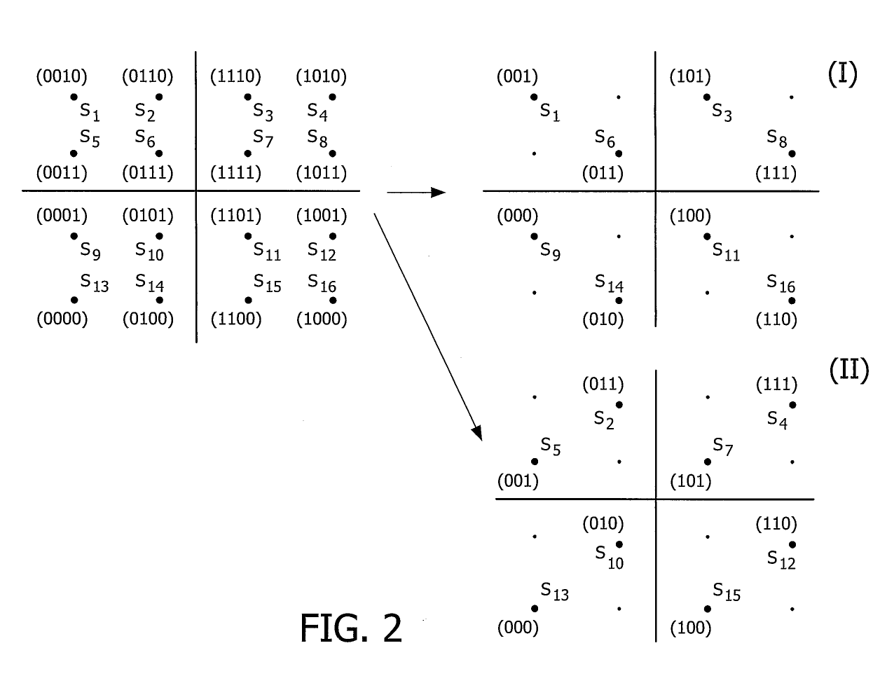

FIG. 2 shows a 16QAM modulation constellation and its two primary subset.

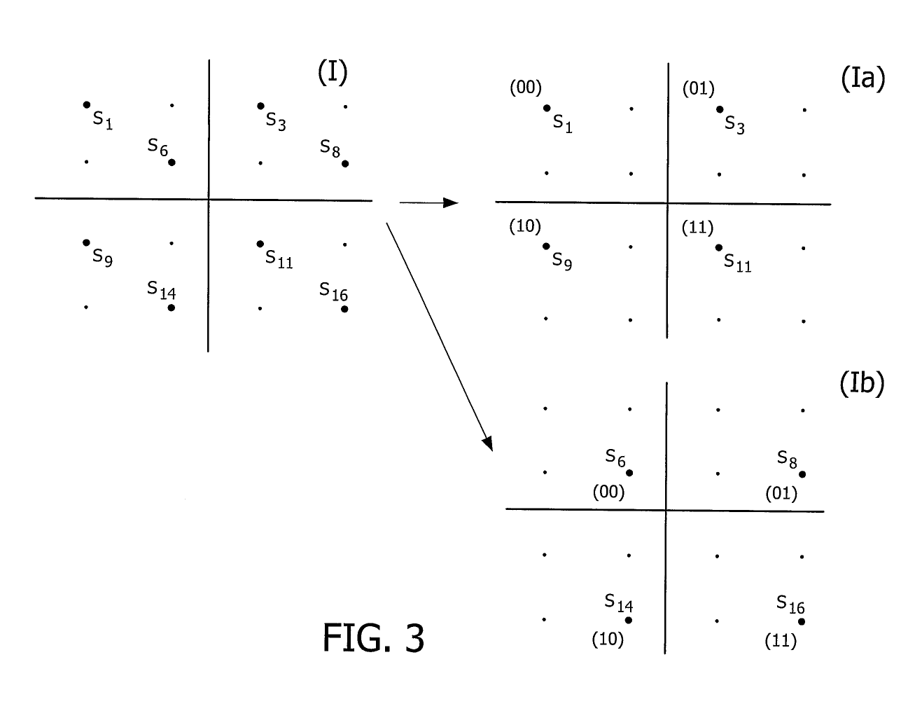

FIG. 3 shows the first primary subset of a 16QAM modulation constellation and its corresponding two secondary subsets.

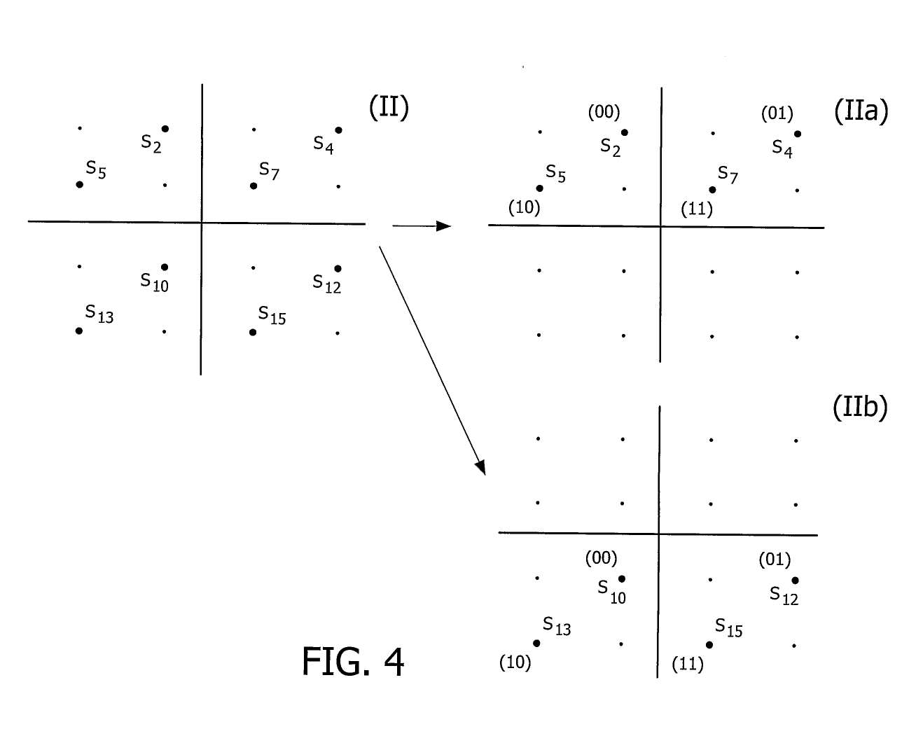

FIG. 4 shows the second primary subset of a 16QAM modulation constellation and its corresponding two secondary subsets.

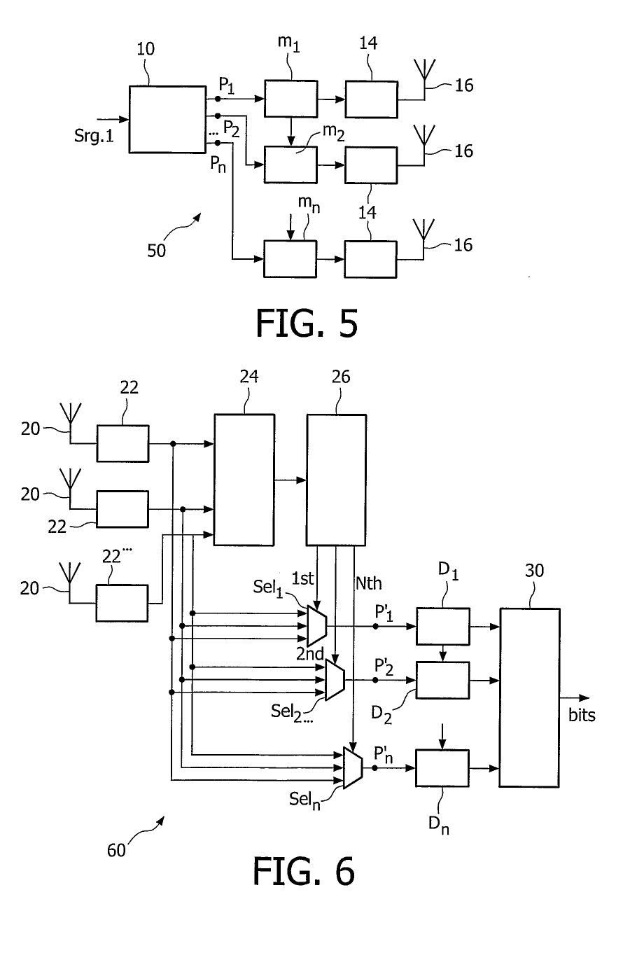

FIG. 5 shows an embodiment of a transmitter that is arranged for encoding a bit-sequence according to the invention.

FIG. 6 shows an embodiment of a receiver that receives signals that are encoded according to the invention.

The following relation gives the transmission model of a MIMO system:

r=H.x+n (1)

Wherein H represents the channel transfer matrix having elements hᵢⱼ, x denotes the transmitted data stream. x is a vector of size Ntx by 1. Ntx represents the number of transmitted data streams. n denotes the noise vector and r represents the received data streams. r is a vector of size Nrx by 1 wherein Nrx represents the number of received data streams.

In a digital transmission system, the bits are mapped onto the symbols xᵢ, i=1 . . . Ntx. According to the invention, the mapping process is done in such a way that the mapping of each of the data stream has an influence on the other remaining data streams. According to the invention, this can be achieved by using subsets of a modulation constellation for the encoding of each of the streams. In principle the choice of a subset for the decoding of one of the streams is determined by the symbols that have been selected for the encoding of the previous streams. According to the invention, the subsets are selected according to a predefined set of rules, which are known by both transmitter and receiver. Additionally, the transmittable data streams are encoded in a certain order. The invention can be carried out by using any modulation constellation using more than two symbols such as QAM or M-ary PSK. The principle of the invention will be illustrated by means of a number of non-limiting examples.

FIG. 1 shows a QPSK modulation constellation comprising 4 symbols {s₁,s₂,s₃,s₄} for encoding the 2-bit bit sequences 00, 01, 10, 11. According to the example, two streams have to be encoded. The first stream is to be encoded first. Assuming that the first pair of bits are part of subset I={s₂,s₄} then the second stream could be encoded by using the subset II={s₁,s₃}. Since, subset 2 only comprises two symbols, only 1 bit can be encoded at a time for the second stream i.e. either a 0 or a 1. If however, the bits of the first stream were part of subset II, then the bits of the second stream should be encoded by means of symbols from subset I. It is equally possible to device a different rule e.g. if the bits of the first stream are part of subset I, then the bits of the second stream should also be encoded according to the same subset. Or if the bits of the first stream were part of the second subset, then also the second subset should be encoded according to this same subset. In each case a maximum of tree bits could be transmitted i.e. 2 bits on the first stream and 1 bit on the second stream.

FIG. 2 shows a more elaborate modulation constellation suited for 16QAM modulation. Like in FIG. 1, the constellation can be subdivided in two primary subsets I={s₁,s₃,s₆,s₈,s₉,s₁₁,s₁₄,s₁₆} and II={s₂,s₄,s₅,s₇,s₁₀,s₁₂,s₁₃,s₁₅}. Again the first stream can select any symbol of the modulation constellation to encode a four-bit bit sequence. Assuming that the selected symbol is part of primary subset I, then the bits from the second stream should be encoded by means of the primary subset II. Primary subset II comprises 8 symbols. Therefore, only three bits per symbol can be encoded for the second stream. If however, the bits of the first stream would be encoded by means of a symbol that is part of the second primary subset, then the bits of the second stream would also be encoded using symbols of the first primary subset. As previously explained it would also be possible to device a rule through which the second stream is encoded according to the same primary subset as the first stream. In general it would be advisable to maintain a maximum coding distance between symbols of the respective streams. It will be apparent that the coding scheme can easily be extended to encode more than 2 bit streams. An example of a coding scheme for encoding 3 streams is given below. For the coding of the first two streams, the modulation constellation is again subdivided into the two primary subsets I and II as previously described. The first stream can select any symbol of the modulation constellation to encode 4 bits. The selected symbol is either part of the first primary subset I or of the second primary subset II. By means of example it is assumed that the second stream is encoded by using the primary subset that comprises the selected symbol of the first stream. The second stream is free to choose any of the symbols comprised in the primary subset. Since each subset only comprised 8 symbols, the second stream can encode a maximum of 3 bits per symbol. To encode, the third stream, a further subdivision of the primary subsets is required. The first primary subset I is subdivided into secondary subsets Iₐ={s₁,s₃,s₉,s₁₁} and I_{b}={s₆,s₈,s₁₄,s₁₆} (see FIG. 3), the second primary subset II is further subdivided into secondary subsets IIₐ={s₂,s₄,s₅,s₇}, I_{b}={s₁₀,s₁₂,s₁₃,s₁₅} (see FIG. 4). The secondary subset for decoding the third stream is determined by the symbols that were selected to encode the first and second streams. Or to be more specific which of the secondary subsets Iₐ, I_{b}, IIₐ, II_{b} comprises these symbols. The following set of rules could be devised to encode the third stream.

1) Stream 3 uses Iₐ if stream one and stream two transmit a symbol from Iₐ.
2) Stream 3 uses I_{b} if stream one transmits a symbol from Iₐ and stream two transmits a symbol from I_{b}.
3) Stream 3 uses Iₐ if stream one transmits a symbol from I_{b} and stream two transmits a symbol from Iₐ
4) Stream 3 uses IIₐ if stream one and stream two transmit a symbol from IIₐ.
5) Stream 3 uses II_{b} if stream one transmits a symbol from IIₐ and stream two transmits from a symbol from stream II_{b}.
6) Stream 3 uses IIₐ if stream one transmits a symbol from II_{b} and stream two transmits a symbol from stream IIₐ.

It will be apparent to the skilled reader that each secondary subset comprises four symbols, such that only 2 bits can be transmitted over the third stream. In total for all streams this would yield 9 bits. It will also be apparent to the skilled person in the art, that also other rule sets can be devised. In addition, it is possible to select other subsets of the modulation constellation. For example, the secondary subset Iₐ, and II_{b} now comprises the symbols {s₂,s₄,s₅,s₇} and {s₁₀,s₁₂,s₁₃,s₁₅}, respectively (see FIG. 4). However, in an alternative configuration the secondary subsets IIa and IIb could comprise symbols {s₂,s₄,s₁₀,s₁₂} and {s₅,s₇,s₁₃,s₁₅}, respectively. This will increase the distance between the symbols (coding distance) of the subsets IIa and IIb, which could result in a more reliable detection of the symbols at a receiver.

For the demodulation of the streams it is of primary importance that the signal to noise ratios of the received streams are known. The signal to noise ratio will depend partially on the used demodulation principle. If for example, no further signal processing is used and at the receiver a maximum likelihood detection scheme is used, than the signal to noise ratio is given by:

$$S N R j = {\sum }_{j = 1}^{Nrx} {\vert {h}_{i , j} \vert}^{2} j = 1 , … Nrx \qquad ( 2 )$$

In this formula Ntx denotes the number of receivers and hᵢⱼ are the coefficients of the channel matrix. However, in case a linear equalizer is used to demodulate the streams, the signal to noise ratio at the output of the equalizer changes accordingly and can be calculated from the channel matrix H and the equalizer coefficients. For a zero forcing equalizer for example, the equalizer matrix F comprising coefficients fᵢⱼ can be derived from the channel matrix H according to:

F=H⁻¹ (3)

After equalizing the received signal r, the following signal results;

F.r.=F.H.x+F.n=x+z (4)

Wherein z denotes the equalized noise signal n. The signal to noise ratio of each stream at the output of the equalizer is given by

$$S N {R}_{i} = A \cdot {P}_{T} / ( {N}_{0} {\sum }_{j = 1}^{Nrx} {\vert {f}_{i , j} \vert}^{2} ) , i = 1 , … Ntx \qquad ( 5 )$$

In this formula PT is the transmitted power, A is the channel attenuation and Nₒ represent the power of the noise signal. For deciding in which of the channels the most signal energy is received it is not required to know the values of A, Pt or Nₒ. What is required though, is knowledge of the propagation channels, which basically means knowledge of the matrix H.

The stream having the highest signals to noise ratio is demodulated first. Additionally, the receiver has to detect which symbol of the modulation constellation has been transmitted. Given this symbol, the receiver can reduce the set of possible options for detecting the symbols of the stream having the second best SNR. Once the symbol of this second stream has been detected, the set for the remaining stream(s) can be reduced even further, which will allow an easy detection of the symbols even under conditions were the received streams have a poor signal to noise ratio. Assume that two bit-streams were transmitted that have been modulated using a QPSK constellation e.g. the one shown in FIG. 1. Assume that stream one is modulated using symbol s₁ and that the second stream is modulated according to the following rule: in case of using symbol s₁ for modulating the first stream, the second stream be modulated using either one of the symbols s₁ or s₃. According to the example, symbol s₃ is chosen to modulate a bit sequence of the second stream. In addition, the second stream is assumed to have the highest signal to noise ratio of the two so that the transmitter will demodulate it firstly. Obviously, the receiver is ignorant of which one of the symbols of the BPSQ constellation has been transmitted over the second stream. Therefore, the receiver has to determine which one of the symbols {s₁,s₂,s₃,s₄}has been transmitted. Assuming a proper detection of symbol s₃ for the second stream, it follows automatically that in this case either one of the symbols s₁ or s₃ must have been transmitted in the first stream. Note that in this case the set of possible options is reduced from four to two.

FIG. 5 shows an embodiment of a transmitter that is arranged for encoding a bit-sequence seq₁ according to the invention. The bits that are to be transmitted are first encoded by means of a channel encoder 10 and distributed (multiplexed) into a number of parallel streams p₁ . . . pₙ. Each stream is coupled through to a modulator M₁-Mₙ, which map the bits onto the symbols of a modulation constellation (e.g. 16QAM). Each modulator M₁-Mₙ is arranged to map bits on to symbols using a subset of the modulation constellation that is determined by the outcome of the preceding modulator M₁-Mₙ, According to the invention, the streams must be encoded in a fixed order although the order can be freely determined. However, the receiver must of course be aware of the order used at the encoder. Assuming that M₁ is to modulate the first stream, it is free to pick any symbol of (a subset of) the modulation constellation. Each modulator M₁-Mₙ is coupled to a front-end 14, which converts the symbols into RF signals and transmits them via antenna 16 to a corresponding receiver.

FIG. 6, shows an example of a corresponding receiver for receiving and demodulating a set of RF signals that have been modulated according to the invention. These RF signals are received by antenna's 20 that are coupled to front-ends 22 so as to obtain a series of streams p′₁ . . . p′ₙ that are coupled through to channel estimator 24 which calculates the channel transfer matrix H. Once the channel estimates are known, the signal to noise ratio's can be calculated in element 26 for example by means of formula 4. Depending on these signal to noise ratio's, it is decided which of the streams is demodulated first. To this end, the receiver comprises a number of selectors SEL₁ . . . . SEL_{N} for coupling the streams p′₁ . . . p′ₙ through to demodulators D₁ . . . Dₙ The order of demodulation is determined by the signal to noise ratio's of the received signals. I.e. the signal p′₁ . . . p′ₙ having the highest signal to noise ratio is demodulated first followed by the signal p′₁ . . . p′ₙ having the next best signal to noise ratio, and so on. The first demodulated symbol determines how to demodulate the next stream. Afterwards, the detected symbols are passed to a channel decoder 30. Obviously, the demodulators must be aware of which subsets could have been used for demodulating each individual received signals p′₁ . . . p′ₙ.

In case white Gaussian noise has been added to the communication channels, which may hamper the correct detection of the symbols at the receiver, the symbol of the relevant set coming closest to the received signal should be chosen as the most likely transmitted symbol. However, if the first stream is demodulated incorrectly at a receiver, there might be a chance that the subsequent streams are also being demodulated incorrect, because the receiver deduces the wrong subsets. Nevertheless, since the reliability of the demodulation can easily be measured at the receiver, it is possible to expand the search of the correct symbols over all symbols of the constellation, instead of using the subsets. Due to the encoding scheme, only a limited amount of symbol constellations are possible. Due to the limitation of the constellation, the distance between the possible constellations increases and the detection becomes more reliable. Furthermore, the reliability of a symbol can e.g. be assessed by the distance of the received signal to the closest constellation point. It is possible to take this reliability information into account during decoding.

It should be noted that the above-mentioned embodiments illustrate rather than limit the invention, and that those skilled in the art will be able to design many alternative embodiments without departing from the scope of the appended claims. All signal processing shown in the above embodiments can be carried in the analogue domain and the digital domain. The invention is not only applicable for a 2×2 system, but may also be used for an M×N system. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Method for encoding at least two data streams (p₁ . . . pₙ) by mapping a bit sequence of each one of the at least two data streams (p₁ . . . pₙ) in a predefined order onto a symbol which is part of one of at least two subsets (I, II, Iₐ, I_{b}, IIₐ, II_{b}) of a modulation constellation in which the one of at least two subset (I, II, Iₐ, I_{b}, IIₐ, II_{b}) is determined by an encoding rule that is having regard to the symbols (s₁ . . . s₁₆) that already have been used for encoding bit sequences of preceding data streams (p₁ . . . pₙ).

2. Transmitter (50) arranged to simultaneously transmit at least two data streams that have been modulated according to the method of claim 1.

3. Method for decoding at least two data streams (p′₁ . . . p′ₙ) that have been encoded according to the method of claim 1, the method comprising the steps of:
determining a decoding order for decoding each one of the at least two data streams (p′₁ . . . p′ₙ); and
decoding each one of the at least two data streams (p′₁ . . . p′ₙ) in the decoding order by demapping a symbol of each one of the at least two data streams (p′₁ . . . p′ₙ) back into bits using one of at least two subsets (I, II, Iₐ, I_{b}, IIₐ, II_{b}) of the modulation constellation, in which the one of at least two subsets (I, II, Iₐ, I_{b}, IIₐ, II_{b}) is determined by a decoding rule that is having regard to the symbols (s₁ . . . s₁₆) of preceding data streams (p′₁ . . . p′ₙ) that already have been demapped.

4. Method according to claim 3, wherein the decoding order is determined by signal to noise ratios of each one of the at least two data streams (p′₁ . . . p′ₙ).

5. Method according to claim 4, wherein a first of the at least two data streams (p′₁ . . . p′ₙ) that is having the highest signal to noise ratio is decoded first.

6. Receiver (60) arranged to receive at least two simultaneously transmitted signals, wherein the received at least two simultaneously transmitted signals are demodulated according to the method of claim 3.

7. Telecommunication system comprising a transmitter according to claim 2.

8. Telecommunication system according to claim 7, further comprising a receiver according to claim 7.
